(19) United States
(12) Patent Application Publication
(10) Pub. No.: US 2005/0007606 A1
(43) Pub. Date: Jan. 13, 2005

(54) Printing apparatus, display method thereof, printing system, display method thereof, program, and memory medium

(75) Inventor: Noriaki Miyasaka, Okaya-shi (JP)

Correspondence Address: HOGAN & HARTSON L.L.P.;Suite 1900, 500 South Grand Avenue, Los Angeles, CA, 90071, US

(73) Assignee: Seiko Epson Corporation

(21) Appl. No.: 10/857,645

(22) Filed: May 28, 2004

(30) Foreign Application Priority Data
May 30, 2003 (JP) 2003/154994
May 30, 2003 (JP) 2003/154995

(51) Int. Cl. G06F 15/00

(52) U.S. Cl. 358/1.1; 358/1.12

(57) ABSTRACT

A printing apparatus has a printing head which gradually prints a print image on an object to be printed, and a display which visibly displays the non-printed portion which gradually decreases with the progress of the printing work of the print image. A printing system has a data server which feeds the print image data through an interface capable of transmitting the print image data, and a printing apparatus which receives the print image data through the data server and gradually prints the print image on the object to be printed based on the print image data. The data server visibly displays the image of the non-printed portion which gradually decreases with the progress of the printing work of the print image.

### BACKGROUND OF THE INVENTION

1. Field of the Invention

This invention relates to a printing apparatus; a display method of a printing apparatus; a printing system in the form of a separate type of printing apparatus which is provided with a feeding apparatus to feed print image data and an apparatus for printing thereof (printing apparatus); a display method of a printing system; a program; and a memory medium.

2. Description of the Related Art

In the conventional printing apparatus, the printing is performed after having confirmed the entire print image by means of a preview, or the like, prior to printing. During printing, the progress in the form of numerical values showing how many per cent of printing has been executed, the message of “printing”, or the like, are displayed on a display screen.

However, it is not possible to grasp the entire print image or the progress of printing by means of display of the numerical value or the display of message alone. In an apparatus in which the print image can be displayed at the time of preview or during printing, the only way to confirm the result of printing (printed portion) that has been finished up to that time point (in the course of printing) in the form of an image during printing is to look at the object to be printed. In either of the above-described cases, it is impossible to grasp in the form of image the non-printed portion during the printing work or printing job. In the printing system which is defined to be a separate type of printing apparatus, the feeding apparatus and the printing apparatus are usually physically disposed at a distance from each other (e.g., in separate rooms). Under such circumstances, the printed portion cannot be grasped on the part of the feeding apparatus in the form of image. In either of the above-described cases, it is impossible to grasp the non-printed portion in the form of image during the printing work.

### SUMMARY OF THE INVENTION

This invention has an advantage of providing a printing apparatus which is capable of grasping, in the form of image, the printed portion and the non-printed portion of a print image during the printing work; a display method of a printing apparatus; a printing system which is capable of grasping, in the form of image, the printed portion and the non-printed portion of the print image during the printing work even in a separate type of printing system; a display method of the printing system; a program; and a memory medium.

According to one aspect of this invention, there is provided a printing apparatus comprising: printing means for gradually printing a print image on an object to be printed; and display means for visibly displaying a non-printed portion of the print image, the non-printed portion gradually decreasing according to a progress of printing of the print image.

According to another aspect of this invention, there is provided a display method of a printing apparatus, comprising visibly displaying by display means a non-printed portion of a print image, the non-printed portion gradually decreasing according to a progress of printing of the print image by printing means on an object to be printed.

According to this printing apparatus and display method, that non-printed portion of the print image which gradually varies (decreases) is visibly displayed according to the progress of printing. Therefore, it is possible to grasp the situation by means of (or in the form of) the print image. In this case, only the non-printed portion may be displayed as an independent image or it may alternatively be displayed together with a printed portion (to be described later) in a manner capable of discriminating (or recognizing) them.

Preferably, the display means visibly displays also a printed portion of the print image, together with the non-printed portion thereof, the printed portion gradually increasing according to the progress of printing.

According to this arrangement, since that printed portion of the print image which gradually varies (increases) according to the progress of printing is visibly displayed together with the non-printed portion of the print image, the displaying makes it possible to grasp the whole of the print image even during the printing work. Further, it is possible to grasp those printed portion and the non-printed portion which gradually vary in the form of image (or by means of image). In this case, the printed portion and the non-printed portion may be displayed as independent images or they may alternatively be displayed within one and the same print image in a distinguishable (or recognizable) manner.

Preferably, the display means comprises: print image display means for displaying on a display screen a whole of the print image; and border movement display means for moving a border mark according to the progress of printing, the border mark showing a border between the printed portion and the non-printed portion within the print image.

According to this arrangement, the entire print image is displayed on the display screen, and the border mark which shows the border between the printed portion and the non-printed portion within the print image is moved depending on the progress of the printing (printing work). Therefore, it is possible to grasp or recognize the change (movement) of the border between the two portions and, as a result, the printed portion and the non-printed portion can be easily grasped in the form of image.

Preferably, the display means comprises print image movement display means for moving the printed portion and the non-printed portion according to the progress of printing while the border between the printed portion and the non-printed portion within the print image is kept stationary.

According to the above arrangement, the border between the printed portion and the non-printed portion is set to be stationary (or fixed), and the printed portion and the non-printed portion are moved in displaying them depending on the progress of printing. Therefore, it is possible to recognize the gradual movement (i.e., relative movement) of the border. As a result, the printed portion and the non-printed portion can be easily distinguished in the form of image. Further, since the border is displayed as being stationary, the border is less likely to be lost even in a small display screen. Since it is only necessary to display at least the neighborhood of the border, the movement of the border can be easily grasped even in a display screen which is difficult of displaying the entire image. It is thus suitable for a small-sized printing apparatus.

Preferably, the display means displays the printed portion and the non-printed portion in display modes which are different from each other.

According to this arrangement, the print image is displayed in a manner to have display modes which are different between the printed portion and the non-printed portion (e.g., in different display density, display color, decoration to be applied to the main body and the background, background pattern, or the like). Therefore, this kind of difference makes it easy to distinguish the printed portion and the non-printed portion in the form of image.

Preferably, the printing apparatus further comprises print stop means for stopping the printing in a course of printing.

According to this arrangement, the printing work can be stopped in the course of the printing. Therefore, in case there has been found a mistake in a portion of the displayed image (e.g., the non-printed portion), the printing work can be stopped at that point of time, whereby the waste of the object to be printed (e.g., printing paper, tape) can be minimized. Further, by stopping the printing work at an arbitrary position, the printing work can be intentionally stopped half (on the way, e.g., at a position in which only half a character has been printed). In this manner, it is also possible to form an image which is ordinarily difficult to form as a (complete or formal) print image.

According to another aspect of this invention, there is provided a printing system comprising: a feeding apparatus for feeding print image data through an interface capable of transmitting the print image data; a printing apparatus which receives the print image data through the interface to thereby gradually print, on an object to be printed, a print image based on the print image data, wherein the feeding apparatus comprises display means for visibly displaying a non-printed portion of the print image, the non-printed portion gradually decreasing according to a progress of printing of the print image.

According to still another aspect of this invention, there is provided a display method of a printing system in which a print image is printed on an object to be printed based on print image data to be fed from a feeding apparatus to a printing apparatus through an interface. The method comprises visibly displaying, by display means of the feeding apparatus, a non-printed portion of a print image, the non-printed portion gradually decreasing according to a progress of printing.

According to the printing system and the display method thereof, that non-printed portion of the image which gradually varies (decreases) with the progress of printing work to be gradually performed by the printing apparatus based on the print image data to be fed to the printing apparatus by the feeding apparatus through the interface, is visibly displayed by the display means of the feeding apparatus. Therefore, the non-printed portion can also be grasped even on the part of the feeding apparatus. In this case, only the non-printed portion may be displayed as an independent image or it may alternatively be displayed together with a printed portion (to be described later) in a manner capable of discriminating (or recognizing) them.

In the printing system, preferably, the printing apparatus gradually receives the print image data to thereby gradually print the print image, and the feeding apparatus further comprises progress determination means which gradually transmits the print image data to thereby determine the progress of printing based on an amount of transmitted print image data.

According to this arrangement of the printing system, the printing apparatus gradually prints the print image while gradually receiving the print image data, and the feeding apparatus gradually transmits the print image data. Therefore, the transmitting (feeding) and the printing are performed in correlation with each other. As a result, the progress of printing can be judged based on the transmitted amount (or quantity), and the gradually decreasing non-printed portion of the image can be displayed.

Preferably, the printing apparatus of the printing system further comprises progress reporting means for reporting the progress of printing of the print image to the feeding apparatus through the interface.

According to this arrangement of the printing system, the printing apparatus reports the printing progress of the print image to the feeding apparatus through the interface. Therefore, it is possible on the side of the feeding apparatus to display the gradually decreasing non-printed portion of the image based on the reported progress of printing. In this case, the printing image data may be transmitted in a lump instead of gradual transmission.

Preferably, in the printing system, the feeding apparatus comprises: print image memory means for storing the print image data; print program memory means for feeding the print image data to the printing apparatus to thereby store a program for displaying the non-printed portion of the image according to the progress of printing; and program execution means for executing the printing program.

According to this arrangement, the print image data is stored and also the printing program for feeding the print image data and for displaying the non-printed image is stored. By executing the program, the function as the feeding apparatus is performed.

In the printing system, the feeding apparatus further comprises mounting means for mounting a memory having stored therein at least one of the print image data and the print program.

According to this arrangement, the feeding apparatus can mount the memory medium having stored therein the print image data or the print program. Therefore, simply by mounting various kinds of memory media, various print image data and print programs can be stored (prepared).

In the printing system in which the print image data and the print program are stored, preferably, the feeding apparatus comprises upper-layer communication means which is connected through a given network to another apparatus to thereby receive from said another apparatus at least one of the print image data and the print program.

According to this arrangement, the feeding apparatus of the printing system is connected to other apparatuses through a given network, whereby the print image data and the print program can be received from other apparatuses. Therefore, by simply receiving them from other apparatuses, various kinds of new print image data and print program can be stored (prepared).

In the printing system, the display means preferably visibly displays also a printed portion of the print image, together with the non-printed portion thereof, the printed portion gradually increasing according to the progress of printing.

According to this arrangement, not only the non-printed portion of the image but also the gradually varying (increasing) printed portion of the print image can be visibly displayed. By this displaying, the entire print image can be grasped even in the course of printing work. It is also possible to grasp the gradually varying completed portion and the non-completed portion in the form of image. In this case, the printed portion and the non-printed portion may be displayed as separate images or else they may alternatively be displayed together within a single print image in a manner capable of discriminating (or recognizing) them.

In the printing system, the display means preferably comprises: print image display means for displaying on a display screen a whole of the print image; and border movement display means for moving a border mark according to the progress of printing, the border mark showing a border between the printed portion and the non-printed portion within the print image.

According to this arrangement, display is made of the entire print image, and the border mark which shows the border between the printed portion and the non-printed portion within the print image is moved depending on the progress of printing. Therefore, the gradual varying (moving) of the mutual border can be grasped. As a result, the printed portion and the non-printed portion can be easily separated and grasped by means of print image.

In the printing system, preferably, the display means comprises print image movement display means for moving the printed portion and the non-printed portion according to the progress of printing while the border between the printed portion and the non-printed portion within the print image is kept stationary.

According to this arrangement, the border between the printed portion and the non-printed portion within the print image is kept stationary, and the printed portion and the non-printed portion are displayed while being moved depending on the progress of printing. Therefore, the gradual change (relative movement) of the border can be grasped and thus the printed portion and the non-printed portion can be easily grasped by distinguishing them by means of image. Further, since the border is displayed in a stationary manner, the border is less likely to be lost even in a small display screen. It is required to display at least the neighborhood of the border. It is thus possible to grasp the (movement of the) border even in case the whole of the print image cannot be displayed on the display screen. It is therefore suitable for a printing system having, as the feeding apparatus, a small-sized device with a display device such as a terminal adapter, or the like.

Preferably, the display means displays the printed portion and the non-printed portion in display modes which are different from each other.

According to this printing system, the print image is displayed such that the printed portion and the non-printed portion have different display modes (e.g., display density, display color, decoration to be given to the main body and the background, pattern of the background, or the like). It is, therefore, possible to easily grasp the difference by means of the print image.

The printing system preferably further comprises print stop means for stopping the printing in a course of printing.

According to this printing system, the printing operation can be stopped in the course of printing. Therefore, in case where a mistake is found in a part (e.g., non-printed portion) of the displayed print image, the printing work can be stopped at the timing of having found the mistake. The waste of the object to be printed (printing paper, printing tape, or the like) can thus be minimized. Further, by stopping the printing work at an arbitrary position, it is possible to print an image which is ordinarily difficult of preparing, e.g., by intentionally stopping the printing in a odd manner such as by printing an image of a single character up to half the position.

Preferably, the object to be printed is a tape.

According to this arrangement, since the object to be printed is a tape, the above-described printing apparatus and the printing system can be applied to a tape printing apparatus.

According to another aspect of this invention, there is provided a program for causing to function each of the means of the printing apparatus as well as of the printing system.

According to this arrangement, the programs can be used for processing in a programmable printing apparatus and a printing system. Therefore, it is possible to grasp the printed portion and the non-printed portion of the print image while the printing is going on.

According to still another aspect of this invention, there is provided a program capable of performing the display method of the printing apparatus and of performing the display method of the printing system.

According to this arrangement, these programs are used for processing in a programmable printing apparatus and a printing system. Therefore, it is possible to grasp the printed portion and the non-printed portion of the print image while the printing is going on.

According to yet another aspect of this invention, there is provided a memory medium for storing each of the above-described programs in a manner to be readable by a printing apparatus as well as by a printing system capable of program-processing.

According to this arrangement, the memory medium is used for processing in a printing apparatus and in a printing system by reading the program stored in the memory medium. Therefore, it is possible to grasp the printed portion and the non-printed portion of the print image while the printing is going on.

### BRIEF DESCRIPTION OF THE DRAWINGS

The above and other objects and the attendant features of this invention will become readily apparent by reference to the following detailed description when considered in conjunction with the accompanying drawings wherein:

FIG. 1 is an external perspective view of a tape printing apparatus according to one embodiment of this invention;

FIG. 2 is a perspective view of the printing apparatus in FIG. 1 in a state in which a lid is left open;

FIG. 3 is a general block diagram showing the control system of the tape printing apparatus in FIG. 1;

FIG. 4 is a flow chart showing general processing of the entire control of the tape printing apparatus;

FIG. 5 is an explanatory figure showing an example of display screen at the time of printing and typical operations on the screen, as well as an explanatory figure showing the result of that printing;

FIG. 6 is an explanatory figure showing a typical enlarged display screen out of those in FIG. 5;

FIG. 7 is an explanatory figure, similar to that in FIG. 5, showing an example in which a printing error has been found;

FIGS. 8A through 8D are explanatory figures of display screen and printing result showing another example in which a printing error has been found;

FIGS. 9A through 9D are explanatory figures other than those in FIGS. 6 and 7, showing other various display examples which are capable of visual distinction to distinguish the printed portion and the non-printed portion;

FIG. 10 is an explanatory figure similar to the one in FIG. 5, showing an example of movably displaying the printed portion and the non-printed portion with the border therebetween being kept stationary;

FIG. 11 is an explanatory figure showing an example of a first constitution of the printing system according to the second embodiment of this invention;

FIG. 12 is an explanatory figure, similar to that in FIG. 11, showing a second constitution of the printing system;

FIG. 13 is a general block diagram showing the control system of the tape printing apparatus in the first and second constitutions in FIG. 11 and 12, respectively;

FIG. 14 is an explanatory figure, similar to that in FIG. 11, showing a third constitution of the printing system; and

FIG. 15 is a general block diagram, similar to that in FIG. 13, showing the third constitution of the printing system.

### DETAILED DESCRIPTION OF THE PREFERRED EMBODIMENTS

With reference to the accompanying drawings, a description will now be made about a tape printing apparatus according to an embodiment (first embodiment) of this invention.

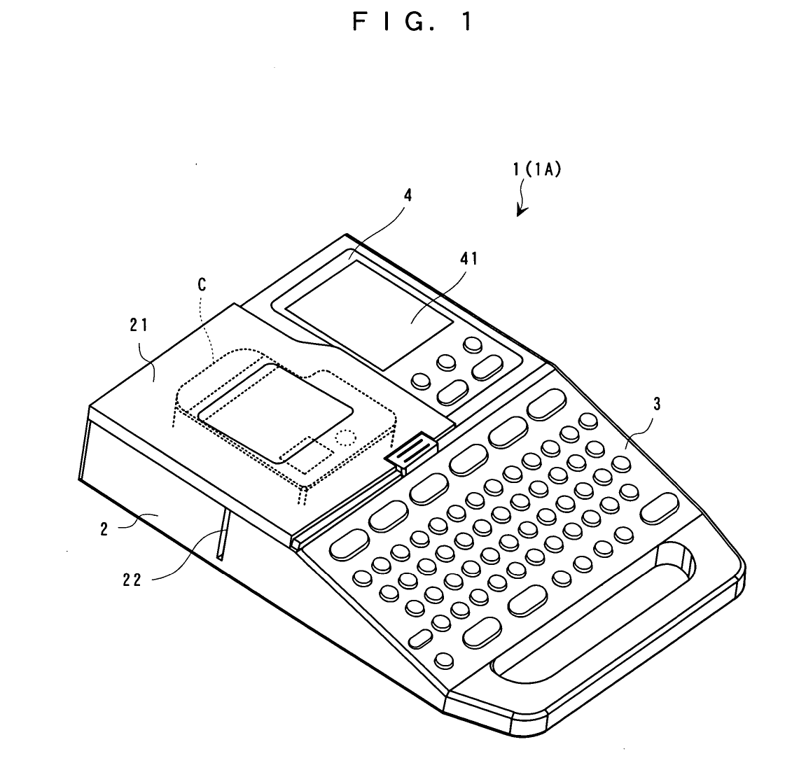

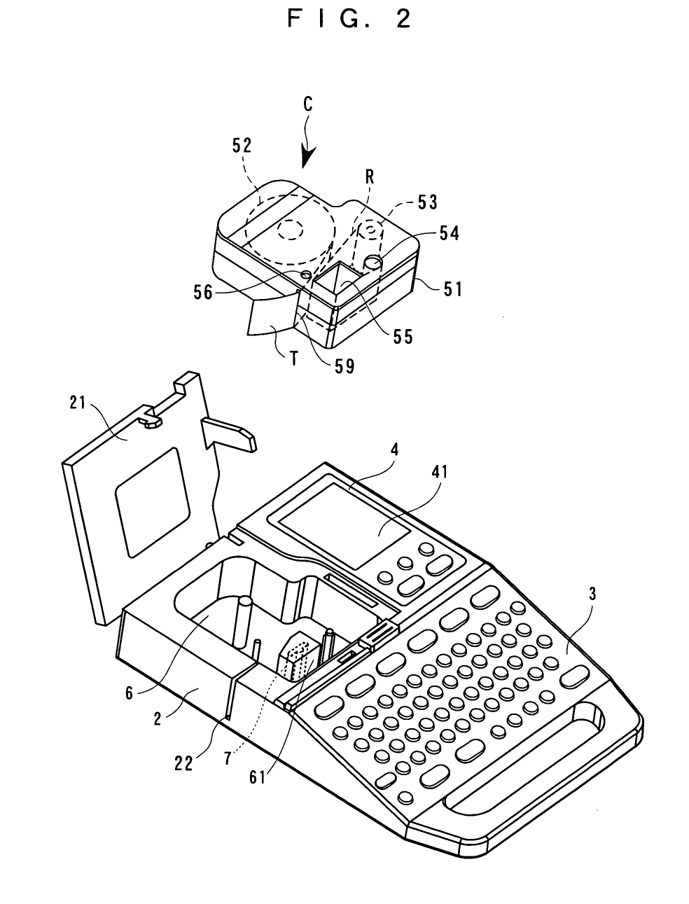

As shown in FIGS. 1 and 2, the tape printing apparatus 1 has an outer shell which is formed by an apparatus casing (apparatus main body) 2. On a front upper face of the apparatus casing 2, there is provided a keyboard 3 which is made up of various input keys. On a rear upper surface thereof, there is attached an opening-closing lid 21, and a display 4 is disposed on the right side thereof. On the left side of the apparatus casing 2, there is formed a slit-like tape discharge port (opening) 22 which communicates a pocket (tape mounting part) 6 with an outside of the apparatus. The tape discharge port 22 has disposed therein a tape cutter 132 for cutting a printing tape (hereinafter referred to also as a “tape”) that has been discharged.

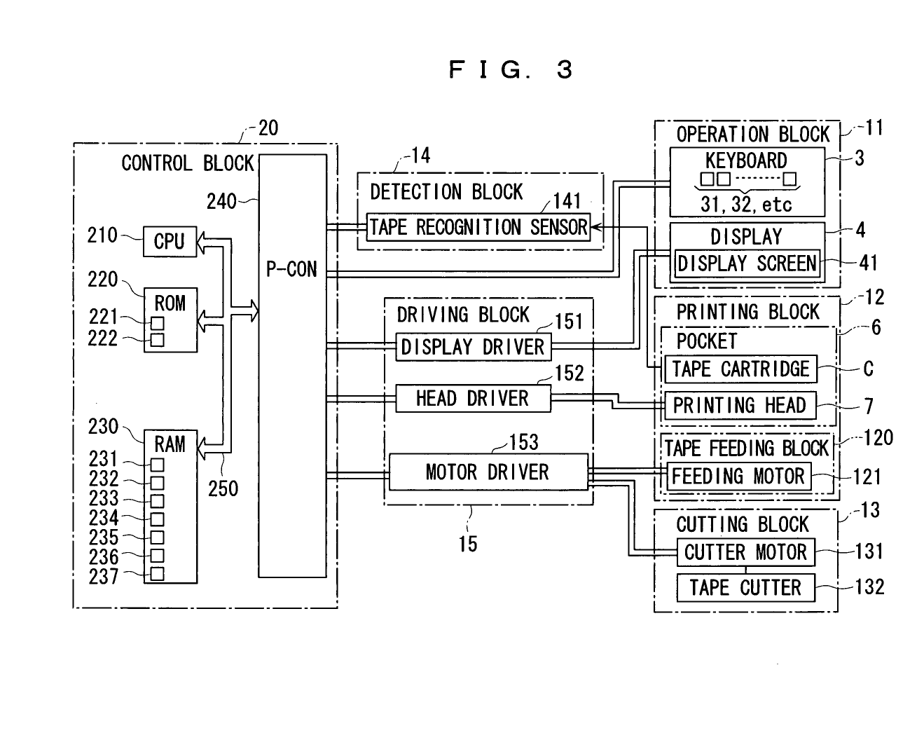

As shown in FIG. 3, the basic constitution as seen from the viewpoint of the control system is made up of: an operation block 11 which has the keyboard 3 and the display 4 and which serves the function of interface with a user; a printing block 12 which has a printing head (thermal head) 7 and a tape feeding block 120 which performs or executes printing of the tape T of a tape cartridge C; a cutting block 13 which performs cutting of the printed tape T; a detection block 14 which has various sensors and performs various detections; a driving block 15 which has various drivers and drives circuit of each of the blocks; and a control block 20 which controls each of the blocks of the tape printing apparatus 1. The tape printing apparatus 1 has mounted therein circuit boards (not illustrated), aside from the printing block 12, the cutting block 13, the detection block 14, or the like. These circuit boards have mounted thereon each of the circuits for the driving block 15 and the control block 20, aside from a power unit, which are connected to a connection outlet for an AC adapter and a battery (not illustrated) such as a Ni—Cd battery which is replaceable from outside.

In the tape printing apparatus 1, after mounting a tape cartridge C into the pocket 6, the user then inputs through the keyboard 3 print information such as desired characters (such as letters, figures, marks, symbols, or the like) by confirming the result of input and edition on the display 4. Upon subsequent command of printing, the tape T is fed (or taken out) of the tape cartridge C by means of the tape feeding block 120, thereby executing desired printing on the tape T by means of the printing head 7. The portion having printed thereon the necessary print image (also referred to as printed portion) is discharged outside through the tape discharge port 22. Once the desired printing has been finished, the tape feeding lock 120 feeds the tape T up to the position of the tape length inclusive of the margin, and then stops the feeding operation.

As shown in FIGS. 2 ad 3, the printing block 12 is provided, on the inside of the opening-closing lid 21, with the pocket 6 for mounting the tape cartridge C therein. The tape cartridge C is mounted on, and dismounted from, the pocket 6 in a state in which this opening-closing lid 21 is left open. The tape cartridge C is provided on its rear surface thereof with a plurality of small holes (not illustrated) so as to enable recognition of the kind of the tape T with different widths or the like. The pocket 6 is provided with a tape recognition sensor 141 such as a micro-switch to detect the presence or absence of these holes. It is thus so arranged that the presence or absence (strictly speaking, as to whether the tape cartridge C is mounted or not) as well as the kind of the tape T (strictly speaking, the kind of the tape cartridge C).

The tape cartridge C is constructed such that a cartridge casing 51 contains therein a tape T and an ink ribbon R of a predetermined width (about 4.5 mm-48 mm) and that a through opening 55 is formed to which the printing head 7 faces. The tape T has an adhesive layer which is formed on a rear surface thereof, and the adhesive layer is covered with a release (peel-off) paper. In a portion in which the tape T and the ink ribbon R are overlapped with each other, there is contained a platen roller (platen) 56 in a manner to correspond to the printing head 7 housed (or contained) inside the head unit 61. In a state in which the tape cartridge C is mounted, the printing head 7 comes into contact with the rear surface of the ink ribbon R that is exposed from the through opening 55 and, due to thermal driving, the desired characters, or the like, are printed on the front surface of the tape T.

The tape feeding block 120 is disposed in a space of the side of the pocket 6 and downward, and is provided with a feeding motor 121 as the power (driving) source. Once the tape cartridge C is mounted in the pocket 6 and the opening-closing lid 21 is closed in that state, the tape T is fed out of a tape reel 52 and the ribbon R is fed from a ribbon feeding reel 53 with the feeding motor 121 serving as the driving source. As a result, the printing head 7 comes into contact with the platen 56 at a position of the through opening 55 in a state in which the tape T and the ink ribbon R are sandwiched therebetween. The tape T and the ink ribbon R travel in an overlapped state and the printing head 7 is driven in a synchronized manner, thereby executing printing. Thereafter, only the tape T is discharged outside the tape cartridge C. The platen 56 is then kept on rotating (a ribbon take-up reel 54 is also rotated in a synchronized manner) for a predetermined period of time. The tape T is thus discharged through the tape discharge port 22 to the outside of the printing apparatus, and a predetermined cutting position of the tape T is fed to the position of the tape cutter 132.

The cutting block 13 is provided with the tape cutter 132, and the cutter motor 131 which operates the tape cutter to perform cutting operation. The cutting block 13 is capable of switching between automatic operation and manual operation by mode setting. In case of printing of an arbitrary length, the cutting key for manual operation (manual) is operated, and in case of printing of a fixed length, the cutting key for automatic printing (auto) is operated to thereby drive the cutter motor 131. The detection block 14 is provided, inside the apparatus, with various kinds of sensors, aside from the above-described tape recognition sensor 141. The driving block 15 is provided with a display driver 151, a head driver 152, and a motor driver 153. The display driver 151 drives the display 4 of the operation block 11 according to a command based on a control signal to be issued by the control block 20. Similarly, the head driver 152 drives the printing head 7 of the printing block 12. The motor driver 153 drives the various motors such as the feeding motor 121 of the printing block 12, the cutter motor 131 of the cutting block 13, or the like.

The operation block 11 is provided with the keyboard 3 and the display 4. Inside a rectangular shape of about 6 cm in width (X direction) and 4 cm in length (Y direction), the display 4 has a display screen 41 which is capable of displaying display image data of 96 dots×64 dots, and 18 indicators (not illustrated) which display various setting conditions, or the like. The display 4 is used by the user to input data from the keyboard 3 in preparing and editing the print image data such as character string image data, in visually recognizing the result thereof, in inputting various commands and selection commands from the keyboard 3, or the like.

The keyboard 3 has disposed therein a character key group 31 inclusive of alphabetical key group, numerical key group, Japanese “kana” key group such as “hirakana”, “katakana”, or the like, and external character key group for calling up external characters and selecting them, as well as function key group 32 for designating various operation modes, or the like.

The function key group 32 includes power supply key, print key for commanding the printing operation, selection key for data determination and changing line at the time of text inputting and for selecting and commanding various modes in selection screen, delete key for deleting various operations or for deleting characters when necessary after having fixed them, cutting key for executing the above-described manual cutting, 4 cursor keys for moving the cursor and display range on the display screen 41 in the up and down as well as in the left and right directions, or other keys. It is possible to provide independent keys for each key inputting, or to utilize them by combination with shift key, or the like, so that input can be made by smaller number of keys. The keyboard 3 is used to input various commands and data into the control block 20 by means of these various keys.

The control block 20 is provided with CPU 210, ROM 220, RAM 230 and peripheral controller (P-CON) 240, which are connected to one another by means of an internal bus 250. The ROM 220 has a control program area 221 which stores therein a control program for processing in the CPU 210, and a control data area 222 which stores therein font data of characters, or the like, (inclusive of numerals, marks, figures, or the like) prepared in the apparatus, color conversion table, character modification table, or the like. The RAM 230, which is backed up for power-off, has various flag/register group 231, text data area 232, display image data area 233, print image data area 234, drawing register image data 235, external character register image data area 236, buffer area 237 such as character development buffer, print buffer, or the like, and is used as a working area for various processing.

The P-CON 240 has built therein a logic circuit which supplements the function of the CPU 210 and also handles the interface signals with the peripheral circuits, a function circuit such as a timer which performs various counting, or the like, all being constituted by gate array, custom LSI, or the like. Therefore, the P-CON 240 is connected to the various sensors in the detection block 14 and the keyboard 3. Various detected signals and various command signals, input data, or the like, are taken into the internal bus 250 as they are or with due processing. In cooperation with the CPU 210, the data control signal outputted from the CPU 210 into the internal bus 250 are outputted to the driving block 15 as they are or after due processing.

According to the above-described arrangement, the CPU 210 inputs various detection signals, various commands, various data, or the like, according to the control program in the ROM 220, and processes various data, or the like, inside the ROM 220 and the RAM 230 for further outputting of the control signal into the driving block 15 through the P-CON 240. The print position control, the display control of the display screen 41 are performed and also the printing head 7 is controlled to print on the tape T under the given printing conditions, whereby the entire tape printing apparatus 1 is controlled.

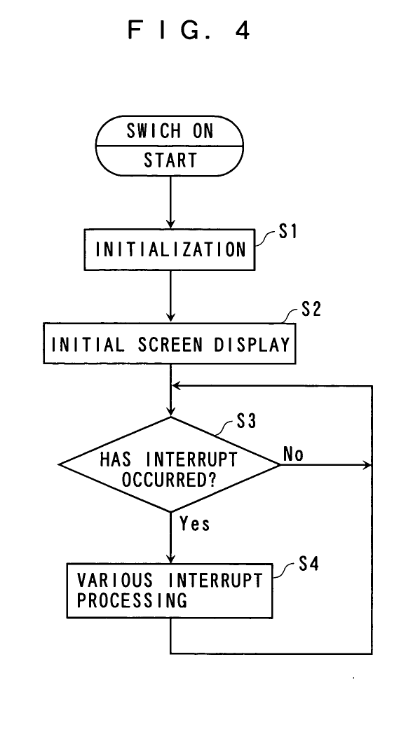

A description will now be made about the processing flow of the entire control of the tape printing apparatus 1 with reference to FIG. 4. When the processing begins by switching on the apparatus (power ON), initialization is performed to bring the state to the one at the time of the last power off such as by restoring each of the retrieved control flags, or the like (S1). The display screen of the last time is displayed as the initial screen (S2).

The subsequent processing in FIG. 4, i.e., a judgment as to whether there is a key input or not (S3) and various interrupt processing (S4), are shown only conceptually. Actually, in the tape printing apparatus 1, when the initial screen display (S2) has been finished, interrupt by means of the key input, or the like, is accepted and, until another interrupt occurs, the state is maintained as it is (S3: NO). If interrupt occurs (S3: YES), the program proceeds to the respective interrupt processing (S4). If that interrupt processing is finished, that state is maintained again (S3: NO).

As described above, in the tape printing apparatus 1, the main processing is performed by interrupt processing. Therefore, if the preparations for print image forming have been made, the user may press the print key at an arbitrary timing. Then, the printing interrupt occurs, the printing processing is started up, and the printing of the print image can be prepared based on the print image data. In other words, the operating procedure to the printing can be arbitrarily selected by the user.

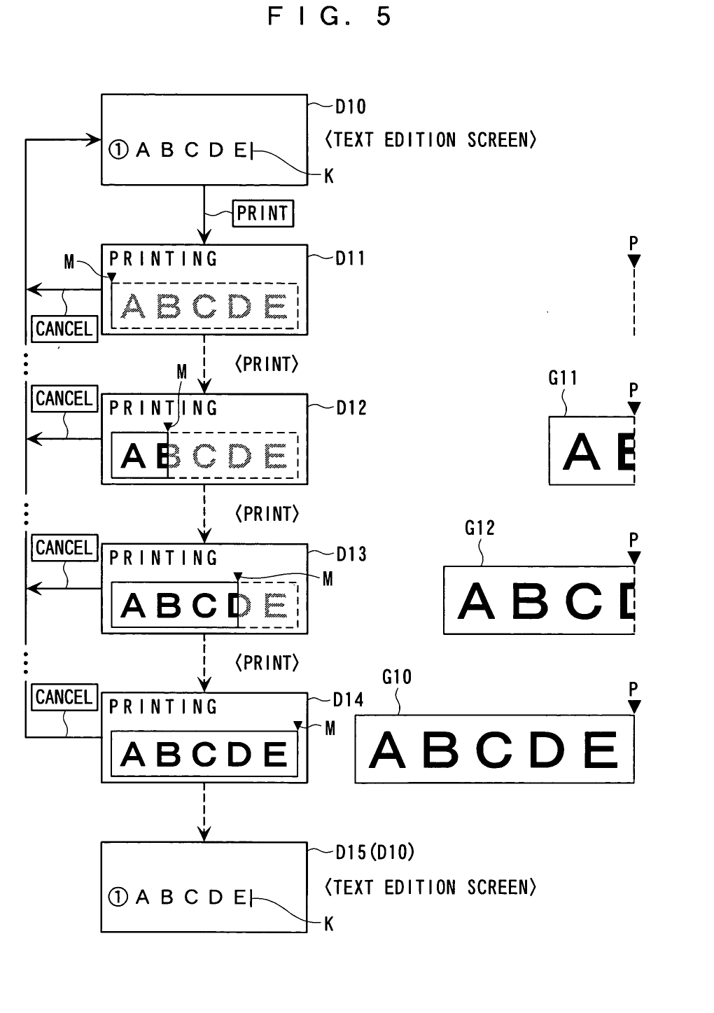

As shown in FIG. 5, when the print key is depressed by the user in a state of display of text edition screen after inputting the first line of character string up to the cursor K (screen D10 in the display screen 41), a message of “printing” is displayed and also the character string image of “ABCDE” is printed as the print image G10 (D11-D14). When the printing is finished, the screen returns to the original text edition screen (D15: same as D10). In the tape printing apparatus 1, the user can delete the various commands by key input. By depressing the “cancel” key in the above-described state (D11-D14), the screen can be returned to the original text edition screen (D10).

In the tape printing apparatus 1, it is possible to grasp the print image of the printed portion (i.e., the portion in which the printing has been finished) and the non-printed portion (i.e., the portion which remains to be printed) in the form of image during printing. A description will now be made about this feature.

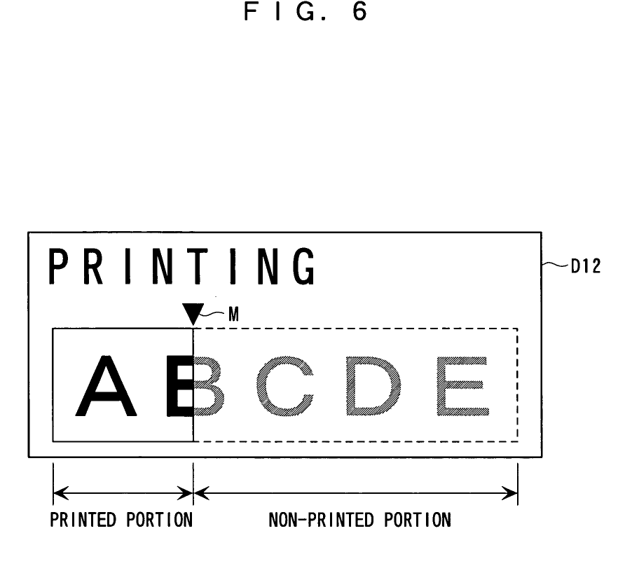

As shown in FIG. 5, when the printing is executed, as an interim or intermediate result of printing operation before the final print image G10 is obtained, the character image of the character string “ABCDE” is gradually printed from one end (in the illustrated example, from the left end) to the opposite end (in the illustrated example, to the right end) as shown in print images G11 and G12. The tape printing apparatus 1 displays the whole of the print image G10 during printing (see FIG. 6 in which the screen D12 corresponding to the print image G11 is shown in an enlarged manner), and also displays printed portion which varies (increases) gradually (or with the lapse of time) in an image of an ordinary density and the non-printed portion which gradually varies (decreases) in an image of a thinner or smaller density. According to this arrangement, the printed portion and the non-printed portion can be easily grasped in the form of image as the difference in the display density.

A border mark M in the form of an indicator, or the like, which shows the border between the printed portion and the non-printed portion is moved (i.e., displayed while allowing to move) inside the display screen 41 in a manner interlocked with the progress of the printing work. According to this arrangement, it is possible to grasp the gradual change (movement) of the border between the printed portion and the non-printed portion. In this manner, the border between the printed portion and the non-printed portion can be grasped more easily by discriminating them in the form of image.

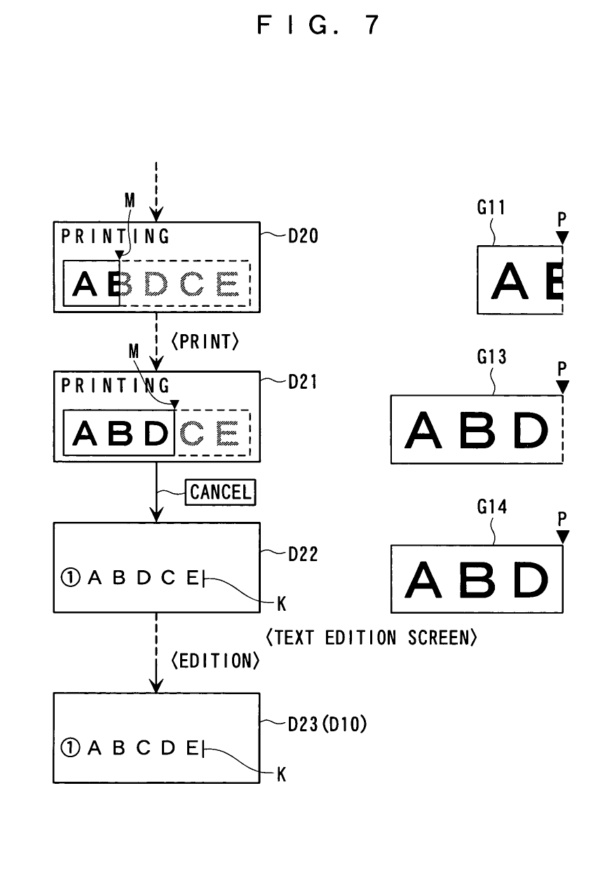

Further, as noted above, the printing can be canceled (stopped) by depressing the cancel key even during the printing work. Therefore, as shown in FIG. 7, while printing is being made of the character string of “ABDCE” which is an error for “ABCDE”, if the error has been noticed right after printing the character “D” which lies in an intermediate portion of the character string (D2 - - - D21), the cancel key may be depressed right away and stop the printing work and thereafter an edition (correction) can be made into a correct character string “ABCDE” (D23: same as D10). In this case, as compared with the case in which the error is noted after having printed to the last character “E”, the waste of the printing tape T can be minimized.

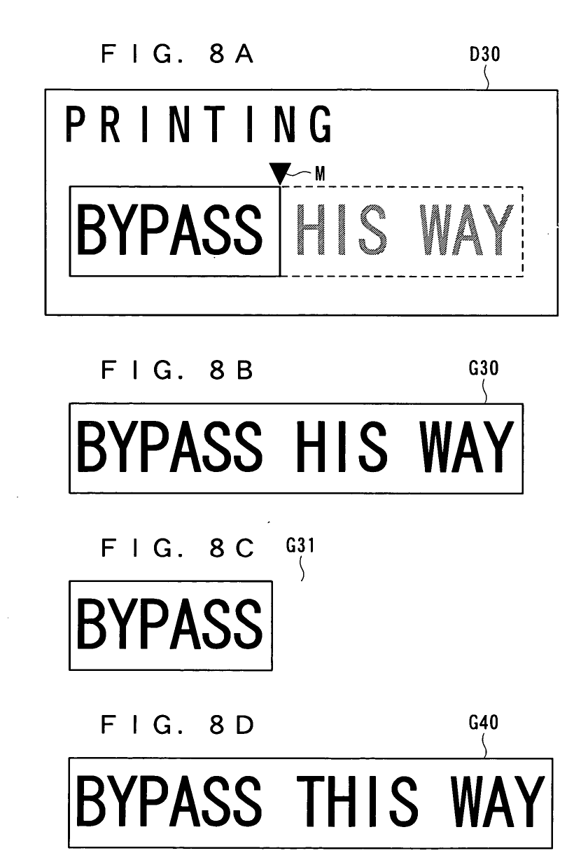

In the tape printing apparatus 1, the display is made in such a manner that the non-printed portion can also be grasped. Therefore, as shown in FIG. 8, if printing work is started after having actually typed “BYPASS HIS WAY” by mistake when it should have been typed as “BYPASS THIS WAY” (see print image G40 in FIG. 8D), the mistake can be recognized by looking at the non-printed portion “HIS WAY.” In this manner, as compared with the case in which the printing is made to the last (see print image G30 in FIG. 8B) before recognizing the error, the printing work can be stopped on the way (see print image G31 in FIG. 8C). By stopping the printing work in a state in which the character “H” in the wrong spelling “HIS WAY” has not been printed out, the waste of the printing tape T can further be reduced to the minimum.

In other words, as described above, the tape printing apparatus 1 makes it easier to recognize a typing error, if any, in a part of the displayed print image (particularly in the non-printed portion). Further, in case such an error has been found, the printing can be stopped right away (i.e., at the point of time of having found the error). The waste in the printing tape T can be minimized.

In the above-described example, the printed portion is displayed in a darker density and the non-printed portion in a lighter density. It may alternatively be so arranged that the non-printed portion (i.e., the content yet to be printed from now on) is displayed in a darker density so as to facilitate recognition. Not only by the display density, but also by the difference in display color can the recognition be made or facilitated. In this case, the difference in halftone value of the same color is generally used as the display density. The difference in the display color is also the difference in halftone value of the primary colors. Therefore, by combining these halftone values, various display densities and display colors can be allocated to the printed portion and the non-printed portion, respectively.

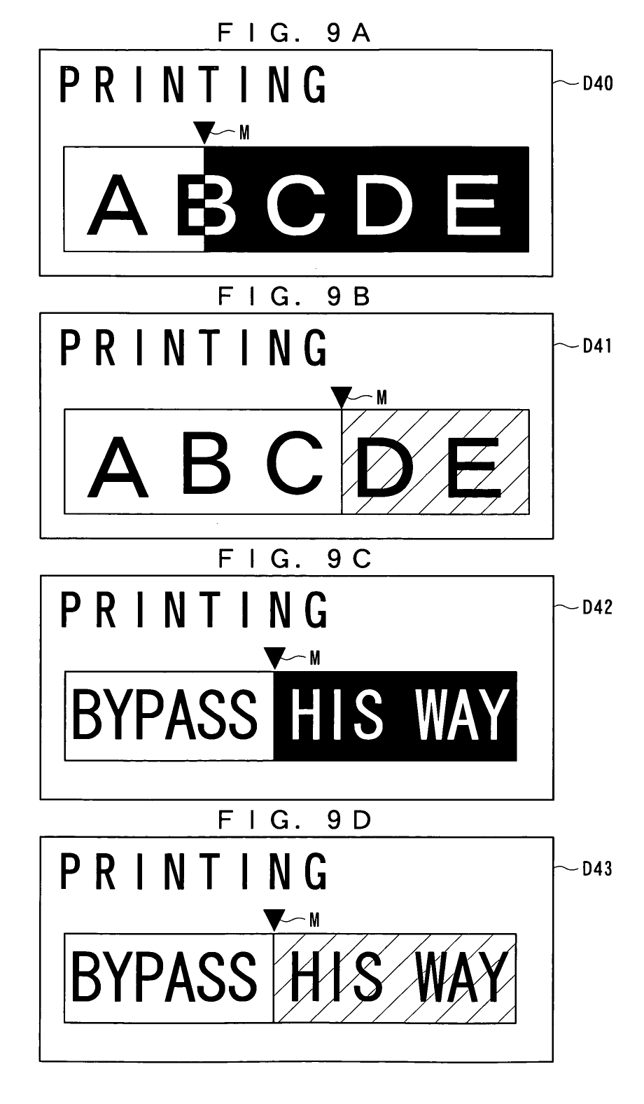

It may also be so arranged that, aside from the differences in display densities and the display colors at the time of an ordinary color display, the monochromatic display, or the like, of very small halftones is possible, whereby the printed portion and the non-printed portion are displayed in reverse video (e.g., in black and white) as in D40, D42 in FIGS. 9A and 9C, respectively. As an example of decoration of other than the display in reverse video, decoration of various colors may be applied to the basic image (character string in the illustrated example) and to the background, respectively, as in D41 and D43 in FIGS. 9B and 9D (shaded background in the illustrated example).

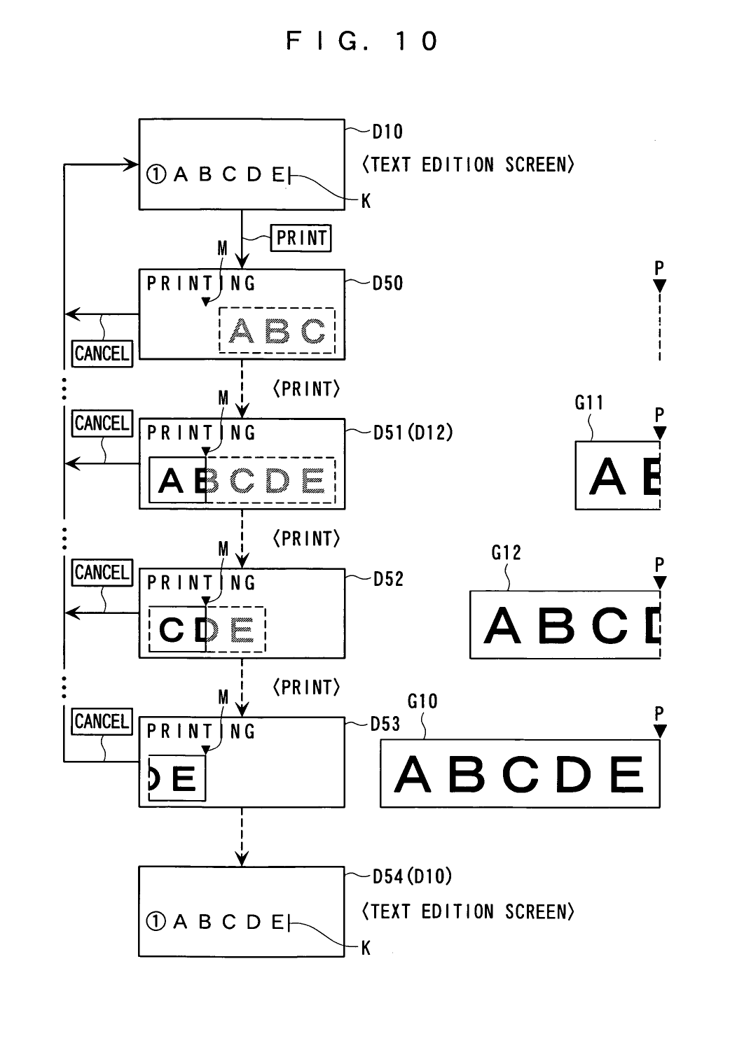

In each of the above-described examples, the whole of the print image is displayed and the border mark M is moved. Alternatively, the border (mark M) may be fixed (or made stationary) so that the printed portion and the non-printed portion are moved depending on the progress of the printing (see FIG. 10). In this arrangement, it is also possible to grasp the gradual change (relative movement) of the border. The border between the printed portion and the non-printed portion can thus be easily grasped in the form of print image. In this case, since the border is displayed as being stationary, the border is hardly lost even in a small display screen. It follows that display may be made at least of the neighborhood of the border. Therefore, even in case the whole print image cannot be displayed on the display screen, (the movement of) the border can be easily grasped. This arrangement is thus suitable for a small-sized printing apparatus.

In case the non-printed portion and the printed portion shall be grasped in a clearer distinction, the printed portion and the non-printed portion may be displayed as independent images. Since the printed portion can be recognized by looking at the result of printing on the object to be printed (tape T), it may be so arranged that only the non-printed portion is independently displayed so as to visually recognize the change (manner of decrease in the amount). Further, in stopping the printing work, not only the cancel key which is used also for canceling other processing, but also an exclusively used (or dedicated) key (print stop key) may be provided.

In the above-described examples, the tape printing apparatus is shown as an example of the printing apparatus. Needless to say, this invention may also be applied to a printing apparatus in which an object to be printed is other than a tape is used (e.g., fixed-size printing paper such as a post card, an envelope, or the like) so that the print image is gradually printed little by little (block by block).

The above-described display method can be applied to a program which is processed by various printing apparatuses which are capable of being processed by means of programs. It is also applicable to a memory medium such as a CD, an MD, a DVD, or the like, which is used for storing this kind of programs. By storing this kind of programs or by reading such programs out of the memory medium for execution thereof, it becomes possible to grasp the non-printed portion and the printed portion of the print image in the form of image during the printing work. Other modifications within the scope not exceeding the substance of this invention is possible.

In the above-described example (fist embodiment), a so-called stand-alone type of tape printing apparatus is shown. A construction (system) in which a similar printing apparatus (tape printing apparatus) is connected to a feeding apparatus which prepares image data (print image data) and feeds to the printing apparatus through communication means can also be regarded as a printing apparatus. A description will now be made about this type of printing apparatus (to distinguish it from the stand-alone type of printing apparatus, this type in question is referred to as a “printing system”) as a second embodiment.

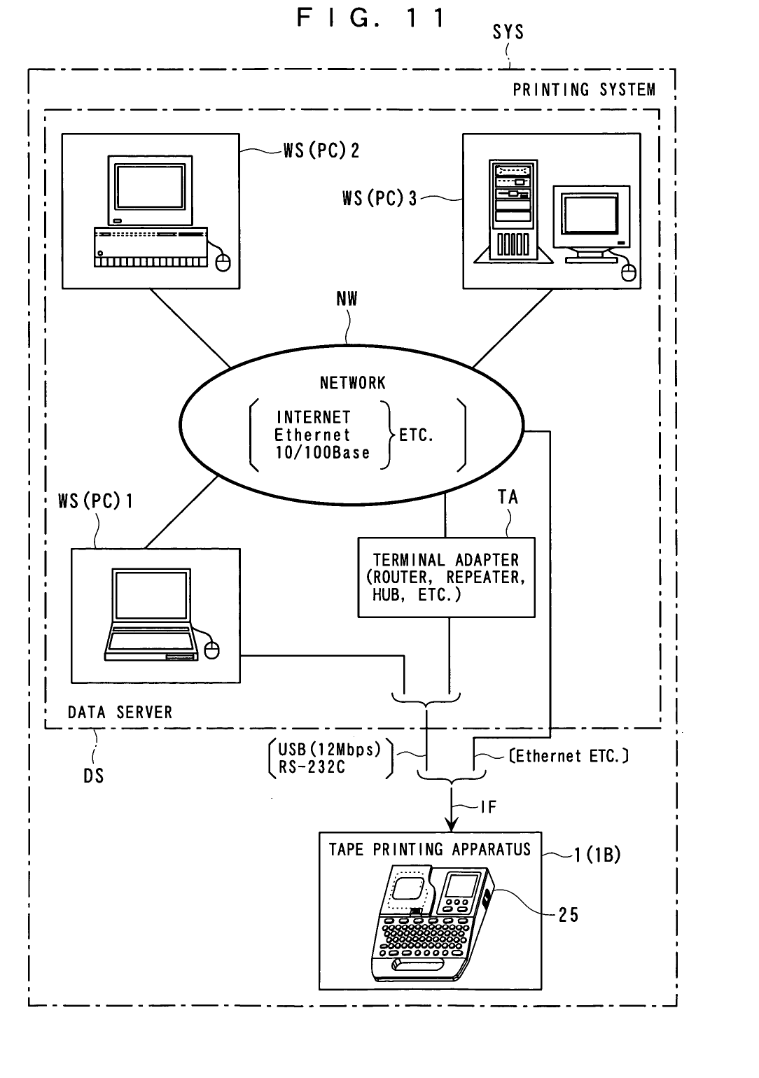

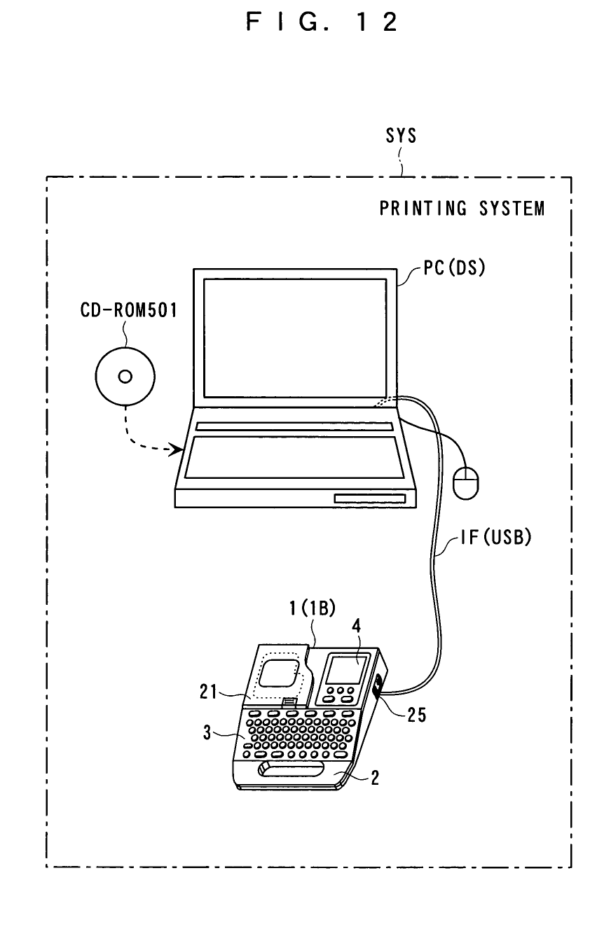

With reference to FIGS. 11 and 12, the tape printing apparatus 1 of this embodiment (in case where distinction is necessary, the printing apparatus according to the first embodiment is referred to as 1A and that of the second embodiment as 1B) is connected to a data server (feeding apparatus) DS through an interface IF, whereby a printing system SYS is constituted as a whole. The data server DS is to serve the print image data to be printed to the tape printing apparatus 1 (1B).

For this purpose, the data server DS is constituted, as shown in FIG. 11, by connecting together through a network NW, a plurality of work stations WS (personal computers, or the like) 1-3, a terminal adapter (inclusive of a router, a repeater, a hub, or the like) TA, or the like. The tape printing apparatus 1 may be connected to any one of the terminals through the interface IF or may be connected directly to the network NW as the interface IF. In this case, as the network NW, there may be employed one according to communication protocols compliant with the IEEA standard LAN, e.g., so-called the Internet, various local area networks (LAN: Ethernet (trademark), 10/100 Base, or the like). The interface IF through the terminals may be of either serial data communication (RS-232C, USBs, IEEE1394, or the like) or parallel data communication (Centronics, or the like). Although the above are standards for wire communication, wireless communication may also be used.

Alternatively, as a simpler constitution, the data server DS may be arranged as a stand-alone type of apparatus. For example, as shown in FIG. 12, by simply connecting the stand-alone type of personal computer PC with the tape printing apparatus 1 (1B) through an interface IF such as the USB, or the like, the printing system can be constituted. In the constitution as shown in FIG. 11 (first constitution), the print image data prepared (stored) in each of the apparatuses (WS 1-3, TA, or the like) in the data server DS is fed (by downloading, or the like) for executing printing. In the constitution as shown in FIG. 12 (second constitution), on the other hand, the print image data stored, e.g., in the personal computer PC (the date server DS) is fed for executing printing.

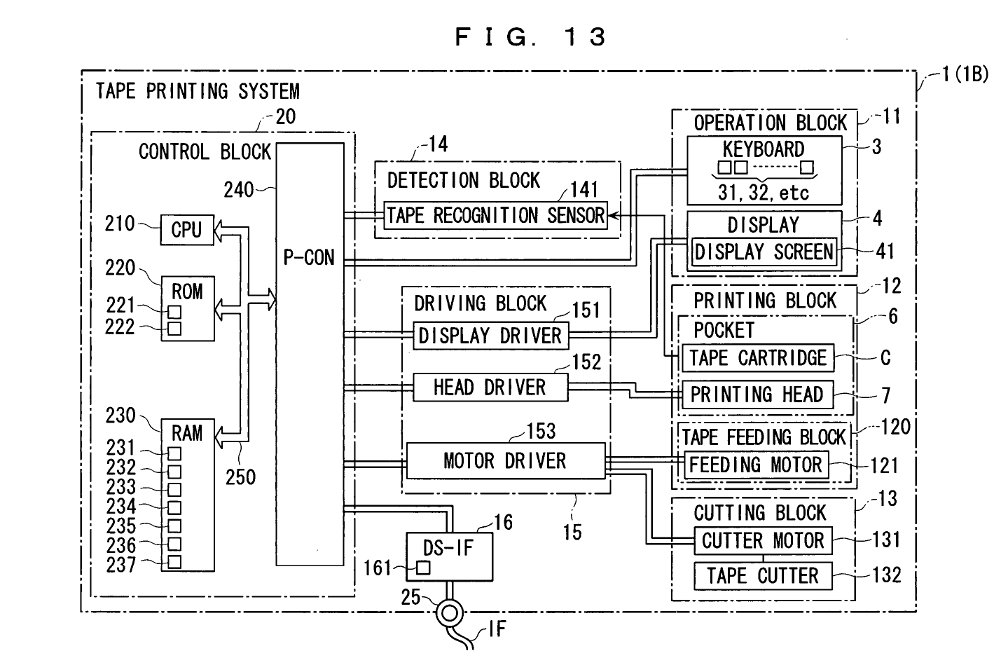

A description will now be made about the second constitution of the printing system SYS as shown in FIG. 12. Here, the tape printing apparatus 1 (1B) is constituted, as shown in FIG. 13, such that the data feeder interface (DS-IF) 16 is added to a constitution similar to that of the tape printing apparatus 1 (1A) of the first embodiment (see FIG. 3). The data feeder interface (DS-IF) 16 communicates with the data server DS through a USB connector 25 from the interface IF (by using a USB cable) based on USB specifications (protocols).

The data feeder interface DS-IF16 has a receiving buffer 161 for receiving various data (print image data, or the like) from the data server DS. The P-CON 240 takes various detection signals from the detection block 14 as described with reference to FIG. 3, various commands from the keyboard 3, input data, or the like, into the internal bus 260. In addition, the P-CON 240 is connected to the DS-IS 16 and takes control signals, various (download) data, or the like, from the data server DS into the internal bus 250 as they are or with due processing thereof. Further, in a manner interlocked with the CPU 210, the P-CON 240 outputs to the driving block 15 and the DS-IF16 the data and the control signals which are outputted from the CPU 210, or the like, to the internal bus 250 as they are or with due processing.

In a state in which the text edition screen similar to the text edition screen (D10) of character string “ABCDE” as shown in FIG. 5 or in which the print image G10 is displayed in the form of image display, if the user gives a predetermined printing command, the data server DS transmits through the interface IF the print image G10 of character string “ABCDE” gradually from one end of the print image G10 (front end: left in the illustrated example) to the opposite end (rear end: right end in the illustrated example).

In the tape printing apparatus 1 (1B) on the other hand, while gradually receiving the print image data of the print image G10 by the DS-IF 16, the print image G10 is gradually printed (similar to G11, G12, or the like, in FIG. 5). In other words, the transmission (feeding) of the print image data and the printing are performed in cooperation with each other.

In the data server DS, while gradually transmitting the print image data, the state of print progress is judged based on the transmitted data. In a similar manner as in the display screen in FIG. 5, the whole of the print image G10 is displayed during the printing work. The printed portion which gradually varies (increases) with the lapse of time is also displayed as an image in an ordinary display density. The border mark M is also displayed while moving in a manner interlocked with the printing progress. According to this arrangement, due to the difference in the display density, the printed portion and the non-printed portion can be easily discriminated in the form of image. At the same time, the gradual change (movement) in the border between the printed portion and the non-printed portion can be easily grasped and can also be easily grasped in the form of image.

The data server DS shall preferably have an arrangement in which the user can issue a command to stop the printing in the course of the printing work. In this case, the printing can be stopped half (i.e., on the way to completion) while the printing is being executed. Therefore, in case, e.g., an error is found in a part of the displayed print image (e.g., in the non-printed portion), the printing work can be stopped at the point of time of having found the error. The waste in the tape (object to be printed) and also in the processing time can be kept to a minimum. In addition, by stopping the printing work at an arbitrary position, the printing can be made, e.g., up to half the position of a single character by intentionally stopping the printing at an intermediate portion so that a print image which is difficult of forming as a print image can still be prepared.

In the above-described examples, the relationship in the display density between the printed portion and the non-printed portion may be made opposite, or the distinction may be made not by the display density but by the difference in the display color (inclusive of the combination of halftone values of each of the primary colors in case of color display). Otherwise, reverse display may also be employed (see D40, D42 in FIG. 9) so as to enable monochromatic display of low halftone, or various kinds of colors may be used in, or decorations applied to, the basic image and the background, or the background pattern may be added (see D41, D43 in FIG. 9).

In a similar manner as described with reference to FIG. 10, the border (mark M) may be arranged to be stationary so that the printed portion and the non-printed portion can be moved in displaying depending on the progress of printing. In this case, the gradual change (relative movement) of the border can be grasped and, therefore, the printed portion and the non-printed portion can be easily grasped by distinguishing them in the form of image. Further, since the border is kept stationary, there is less possibility of losing sight of the border even in a small display screen. Since at least the neighborhood of the border may be displayed, the (movement of the) border can be easily grasped even in case the entire print image is difficult of displaying in the display screen. This arrangement is therefore suitable for a case in which an apparatus with a small display screen is employed as the feeding apparatus such as in the terminal adapter TA as described in the printing system SYS in FIG. 11.

On the other hand, in case a personal computer PC, or the like, having a relatively large display screen is employed as the feeding apparatus, the printed portion and the non-printed portion may be displayed as separate images so as to enable clearer distinction. From the viewpoint in that the printed portion can be confirmed by looking at the result of printing, it may be so arranged that the change in (manner of reducing in) the non-printed portion can be visually recognized in the form of image, thereby enabling to intensively confirm the non-printed portion.

In the above-described example, while the print image data is being gradually transmitted on the side of the data server DS, the progress in printing is judged based on the amount of transmission. It may, however, be so arranged that the progress in printing of the print image is reported to the data server DS from the tape printing apparatus 1 through the interface IF. In this case, on the side of the data server DS, the image of the gradually reducing non-printed portion and the gradually increasing printed portion can be displayed in a manner capable of grasping. The feeding of the print image data may alternatively be made at a high speed (instead of gradually) irrespective of the printing.

In the above-described example, a description is made on the assumption that the print image data is stored (kept in memory) inside the data server DS. However, as shown in FIG. 12, an arrangement may be made such that the print image data is fed from outside by means of a compact disc (CD, CD-ROM) 501, or the like. In this arrangement, various print image data can be alternatively used only by changing the CD-ROM 501.

As regards the program (printing program: exclusively used or dedicated application program) which feeds the print image data by transmitting to the tape printing apparatus 1 to thereby display the image of the non-printed portion, or the like, the program may be prepared (stored) inside the data server DS from the beginning or may be prepared (stored) inside the CD-ROM 501 independently or together with the print image data, thereby starting it up (by downloading, or the like). In this case, if the application is arranged to be capable of being used in a general operation system (OS), it can be used only by mounting the CD-ROM 501 on a personal computer, or the like, equipped with the OS.

Although the CD-ROM was taken as an example in the above description, other media such as a FD, a DVD, or the like, will do as well. In case the network NW is used as in FIG. 11 instead of the constitution as shown in FIG. 12, the print image data and the print program can be received from various kinds of other apparatuses (WS2 and WS3 in the illustrated example) which are connected to the network NW, through the network NW or through the apparatus which is directly connected to the network (feeding apparatus: PC1 and TA in the illustrated example). Therefore, simply by receiving the print image data from various kinds of apparatuses, various new other print image data can be stored (or memorized) or changed. In these cases, in the print program on the side of the data server DS, it is also possible to include a program, capable of utilizing by downloading, on the side of the tape print apparatus.

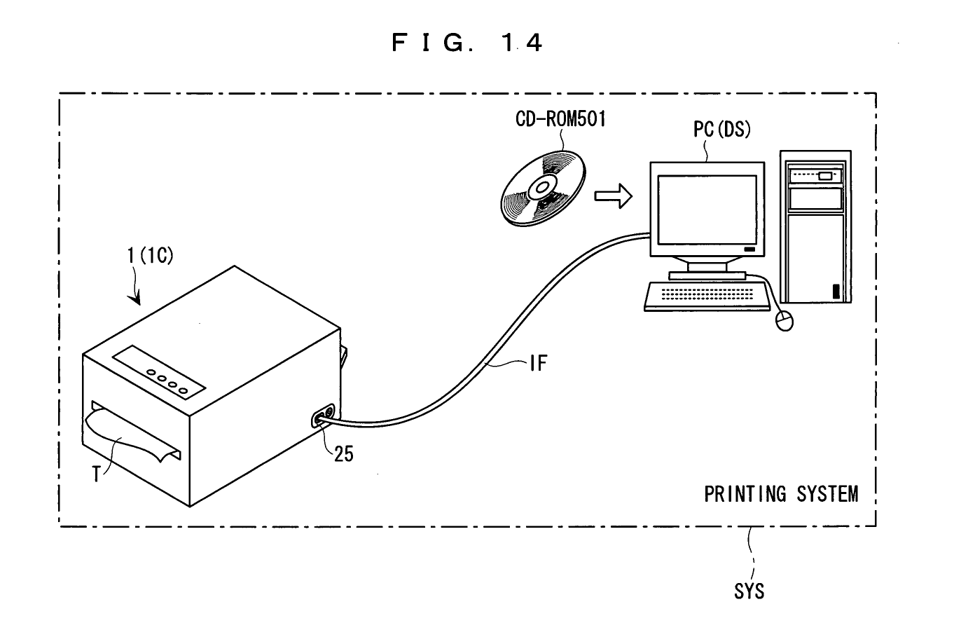

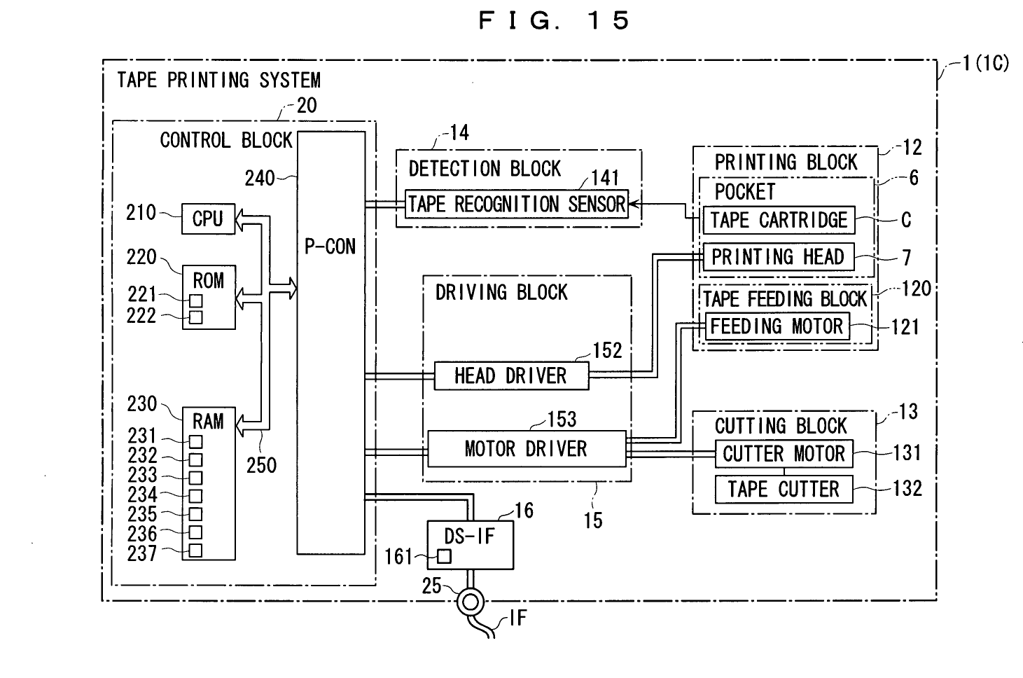

In the above-described second embodiment, the tape printing apparatus which is provided with the operation block 11 having the keyboard 3, display 4, or the like, was cited as the printing apparatus 1 (1B). In case where all or almost all operations are performed according to the commands from the data server DS, the operation block 11, or the like, is not necessary on the side of the printing apparatus. Therefore, there can be employed a constitution in which such functions are omitted. For example, even in a tape printing apparatus which is similar to the tape printing apparatus 1B (see FIGS. 12 and 13), there may be employed a constitution in which the operation block 11, or the like, is omitted as shown in FIGS. 14 and 15.

Furthermore, as the printing apparatus which is connected to the data server DS, there was cited an example of the tape printing apparatus. However, this invention can be applied to other types of printing apparatuses in which the object to be printed is other than a tape as long as they are printing apparatuses in which gradual printing is performed.

The above-described displaying method in the above-described printing system can also be applied as the program to be processed by the programmable various kinds of printing systems, and is also applicable to the various kinds of the above-described memory media for storing therein that kind of a program. Or else, by reading it out from the memory medium, or the like, or by downloading through the network, or the like, thereby performing printing, even in a separate type of printing apparatus; the printed portion and the non-printed portion of the print image can be grasped in the form of image during the printing of the print image. Needless to say, without deviating from the spirit of this invention, changes may be made within a region not deviating from the essence of this invention.

As described hereinabove, according to the printing apparatus, the display method of the printing apparatus, the program, and the memory medium of this invention, there is an effect in that the printed portion and the non-printed portion can be grasped in the form of image while the printing work of the print image is going on. Further, according to the printing system, the display method of the printing system, the program, and the memory medium of this invention, there is also an effect in that the printed portion and the non-printed portion can be grasped in the form of image while the printing work of the print image is going on.

1. A printing apparatus comprising:
printing means for gradually printing a print image on an object to be printed; and
display means for visibly displaying a non-printed portion of the print image, the non-printed portion gradually decreasing according to a progress of printing of the print image.

2. The printing apparatus according to claim 1, wherein the display means visibly displays also a printed portion of the print image, together with the non-printed portion thereof, the printed portion gradually increasing according to the progress of printing.

3. The printing apparatus according to claim 2, wherein the display means comprises:
print image display means for displaying on a display screen a whole of the print image; and
border movement display means for moving a border mark according to the progress of printing, the border mark showing a border between the printed portion and the non-printed portion within the print image.

4. The printing apparatus according to claim 2, wherein the display means comprises print image movement display means for moving the printed portion and the non-printed portion according to the progress of printing while the border between the printed portion and the non-printed portion within the print image is kept stationary.

5. The printing apparatus according to claim 2, wherein the display means displays the printed portion and the non-printed portion in display modes which are different from each other.

6. The printing apparatus according to claim 1, further comprising print stop means for stopping the printing in a course of printing.

7. The printing apparatus according to claim 1, wherein the object to be printed is a tape.

8. A program for causing to function each of the means of the printing apparatus according to claim 1.

9. A memory medium for storing the program according to claim 8 in a manner to be readable by a printing apparatus capable of program-processing.

10. A display method of a printing apparatus, comprising visibly displaying by display means a non-printed portion of a print image, the non-printed portion gradually decreasing according to a progress of printing of the print image by printing means on an object to be printed.

11. A program capable of performing the display method according to claim 10.

12. A memory medium for storing the program according to claim 11 in a manner to be readable by a printing apparatus capable of program-processing.

13. A printing system comprising:
a feeding apparatus for feeding print image data through an interface capable of transmitting the print image data;
a printing apparatus which receives the print image data through the interface to thereby gradually print, on an object to be printed, a print image based on the print image data,
wherein the feeding apparatus comprises display means for visibly displaying a non-printed portion of the print image, the non-printed portion gradually decreasing according to a progress of printing of the print image.

14. The printing system according to claim 13, wherein the printing apparatus gradually receives the print image data to thereby gradually print the print image, and wherein the feeding apparatus further comprises progress determination means which gradually transmits the print image data to thereby determine the progress of printing based on an amount of transmitted print image data.

15. The printing system according to claim 13, wherein the printing apparatus further comprises progress reporting means for reporting the progress of printing of the print image to the feeding apparatus through the interface.

16. The printing system according to claim 13, wherein the feeding apparatus comprises:
print image memory means for storing the print image data;
print program memory means for feeding the print image data to the printing apparatus to thereby store a program for displaying the non-printed portion of the image according to the progress of printing; and
program execution means for executing the printing program.

17. The printing system according to claim 16, wherein the feeding apparatus further comprises mounting means for mounting a memory having stored therein at least one of the print image data and the print program.

18. The printing system according to claim 16, wherein the feeding apparatus comprises upper-layer communication means which is connected through a given network to another apparatus to thereby receive from said another apparatus at least one of the print image data and the print program.

19. The printing system according to claim 13, wherein the display means visibly displays also a printed portion of the print image, together with the non-printed portion thereof, the printed portion gradually increasing according to the progress of printing.

20. The printing system according to claim 19, wherein the display means comprises:
print image display means for displaying on a display screen a whole of the print image; and
border movement display means for moving a border mark according to the progress of printing, the border mark showing a border between the printed portion and the non-printed portion within the print image.

21. The printing system according to claim 19, wherein the display means comprises print image movement display means for moving the printed portion and the non-printed portion according to the progress of printing while the border between the printed portion and the non-printed portion within the print image is kept stationary.

22. The printing system according to claim 19, wherein the display means displays the printed portion and the non-printed portion in display modes which are different from each other.

23. The printing system according to claim 13, further comprising print stop means for stopping the printing in a course of printing.

24. The printing system according to claim 13, wherein the object to be printed is a tape.

25. A program for causing to function each of the means of the printing system according to claim 13.

26. A memory medium for storing the program according to claim 25 in a manner to be readable by a printing system capable of program-processing.

27. A display method of a printing system in which a print image is printed on an object to be printed based on print image data to be fed from a feeding apparatus to a printing apparatus through an interface, comprising visibly displaying, by display means of the feeding apparatus, a non-printed portion of a print image, the non-printed portion gradually decreasing according to a progress of printing.

28. A program capable of performing the display method of the printing system according to claim 27.

29. A memory medium for storing the program according to claim 28 in a manner to be readable by a printing system capable of program-processing.
